(19) United States
(12) Patent Application Publication
(10) Pub. No.: US 2012/0244496 A1
(43) Pub. Date: Sep. 27, 2012

(54) DENTAL POLISHING DEVICE AND METHOD

(75) Inventors: Steven R. JEFFERIES, YORK, PA (US); SIBEL ANTONSON, Davie, FL (US); PAUL D. HAMMESFAHR, WYOMING, DE (US); ROBERT V. HARE, GEORGETOWN, DE (US); PATRICIA W. KIHN, YORK, PA (US); SCOTT G. MCINTIRE, CAMDEN, DE (US)

(73) Assignee: DENTSPLY INTERNATIONAL INC., YORK, PA (US)

(21) Appl. No.: 13/488,632

(22) Filed: Jun. 5, 2012

Related U.S. Application Data
(63) Continuation of application No. 13/299,375, filed on Nov. 18, 2011.
Application No. 13/299,375 is a continuation of application No. 12/708,140, filed on Feb. 18, 2010, now abandoned.

(51) Int. Cl. A61C 17/00; A61C 3/06

(52) U.S. Cl. 433/142; 433/216

(57) ABSTRACT

The invention provides a dental method including forming a polishing member sufficient, when rotated, to polish a cut unpolished dental tooth surface to a surface roughness of less than 0.07 sRa μm and, to polish an unpolished dental restorative material supported by a tooth in a patient's mouth to a surface roughness of less than 0.03 sRa μm. The dental polishing material preferably includes elastomeric polymer impregnated with blocky synthetic diamonds. The synthetic diamonds effectively have particle sizes less than 50 microns. The synthetic diamonds are more than 50 percent by weight of the dental polishing material.

This patent application is a Continuation of U.S. patent application Ser. No. 13/299,375, which claims the benefit of U.S. patent application Ser. No. 12/708,140, which claims the benefit of U.S. patent application Ser. No. 10/289,113, which claims the benefit of U.S. Provisional patent application No. 60/345,396 filed Nov. 9, 2001, and the benefit of U.S. Provisional patent application No. 60/347,980 filed Nov. 7, 2001.

The invention relates to dental polishing device and method of polishing. More specifically the invention provides a dental polishing device and method of polishing tooth and/or restorative with a single polishing member to provide reduced surface roughness.

### BRIEF DESCRIPTION OF THE DRAWINGS

FIG. 1 is a schematic diagram of a polisher supported by a rotator in accordance with the invention.

FIG. 2 is a schematic diagram of a blocky diamond polisher supported by an air driven rotator in accordance with the invention.

FIG. 3 is a perspective side view of a disc shape polishing member on a support member in accordance with the invention.

FIG. 4 is an end view of the disc shape polishing member on a support member shown in FIGS. 3-6.

FIG. 5 is a side view of the disc shape polishing member on a support rod shown in FIGS. 3-6.

FIG. 6 is a cross-sectional side view of a disc shape polishing member on a support rod shown in FIGS. 3-6.

FIG. 7 is a perspective side view of a support rod for supporting a polishing member in accordance with the invention.

FIG. 8 is an end view of the support rod shown in FIGS. 7-10.

FIG. 9 is a side view of the support rod shown in FIGS. 7-10.

FIG. 10 is a cross-sectional side view of the support rod shown in FIGS. 7-10.

FIG. 11 is an end view of a cup shape polishing member on a support rod in accordance with the invention.

FIG. 12 is a side view of the cup shape polishing member on a support rod shown in FIGS. 11-13.

FIG. 13 is a cross-sectional side view of the cup shape polishing member on a support rod shown in FIGS. 11-13.

FIG. 14 is an end view of an elongated conical (point) shaped polishing member on a support rod in accordance with the invention.

FIG. 15 is a side view of the elongated conical (point) shaped polishing member on a support rod shown in FIGS. 14-16.

FIG. 16 is a cross-sectional side view of the elongated conical (point) shaped polishing member on a support rod shown in FIGS. 14-16.

FIG. 17 is a scanning electron micrograph at 1000 magnification of blocky synthetic diamond particles useful in dental polishing material of a dental polishing device of the invention.

FIG. 18 is a scanning electron micrograph at 500 magnification of blocky synthetic diamond particles useful in dental polishing material of a dental polishing device of the invention.

FIG. 19 is a scanning electron micrograph at 200 magnification of blocky synthetic diamond particles in dental polishing material of a dental polishing device of the invention.

### DETAILED DESCRIPTION OF THE INVENTION

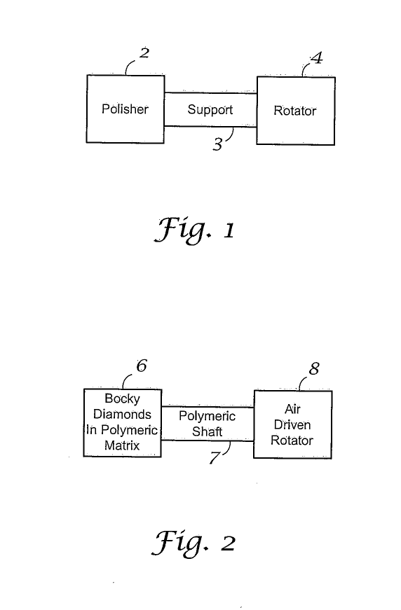

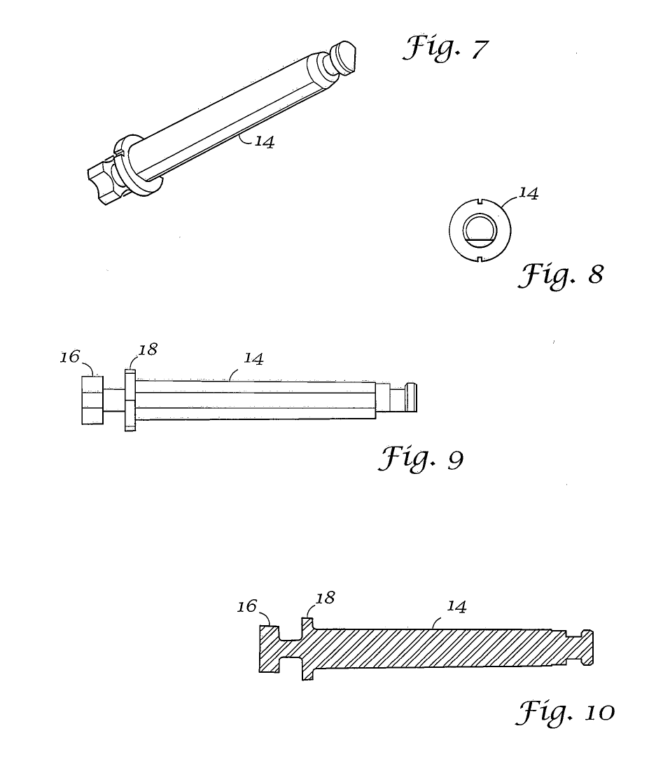

The invention is now described with reference to FIGS. 1-19. With more particular reference to FIG. 1 is seen polisher 2 supported through support 3 by rotator 4 in accordance with an embodiment of the invention. In use polisher 2 is supported and rotated by support 3. Support 3 is supported and rotated by a rotator 4.

With more particular reference to FIG. 2 is seen blocky diamond polisher 6 supported through polymeric shaft 7 by air driven rotator 8 in accordance with an embodiment of the invention. In use blocky diamond polisher 6 is supported and rotated by polymeric shaft 7. Polymeric shaft 7 is supported and rotated by air driven rotator 8.

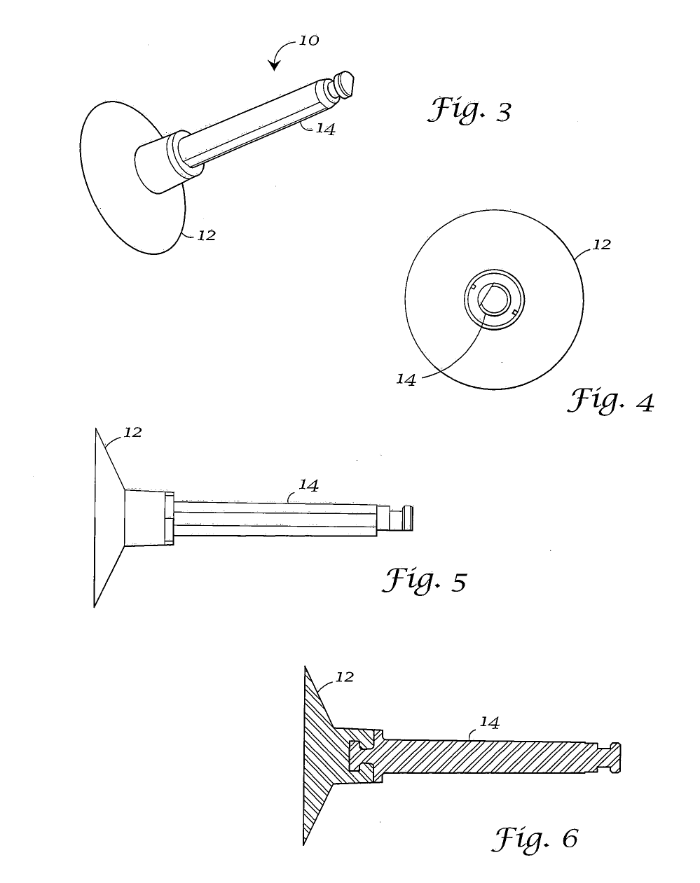

With more particular reference to FIGS. 3-10 is seen a dental polishing device 10 having a disc shaped polishing member 12 and a rigid support rod 14. Rigid support rod 14 has flanges 16 and 18. Disc shaped polishing member 12 is made by molding dental polishing material onto rigid support rod 14 above and adhering to flange 18 while enclosing flange 16. The dental polishing material includes elastomeric polymer impregnated with blocky synthetic diamond particles. The blocky synthetic diamond particles are effectively uniformly distributed within the elastomeric polymer. The blocky synthetic diamonds effectively have particle sizes from 2 to 50 microns. Beneficially, dental polishing device 10 provides a smoother surface in less time than prior art dental polishing systems, for example, that disclosed in U.S. Pat. No. 5,078,754.

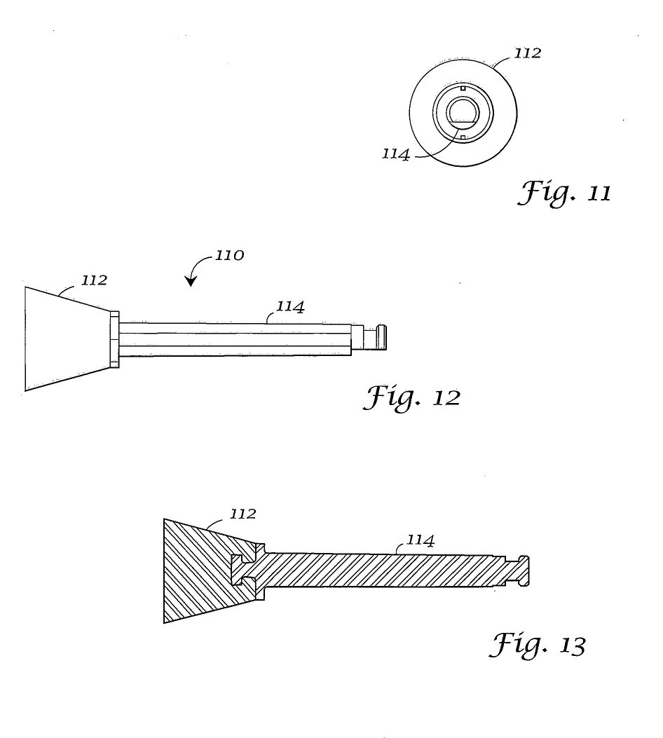

With more particular reference to FIGS. 11-13 is seen a dental polishing device 110 having a cup shaped polishing member 112 and a rigid support rod 114. Cup shaped polishing member 112 is made by molding dental polishing material onto rigid support rod 114. The dental polishing material includes elastomeric polymer impregnated with blocky synthetic diamond particles. The blocky synthetic diamond particles are effectively uniformly distributed within the elastomeric polymer.

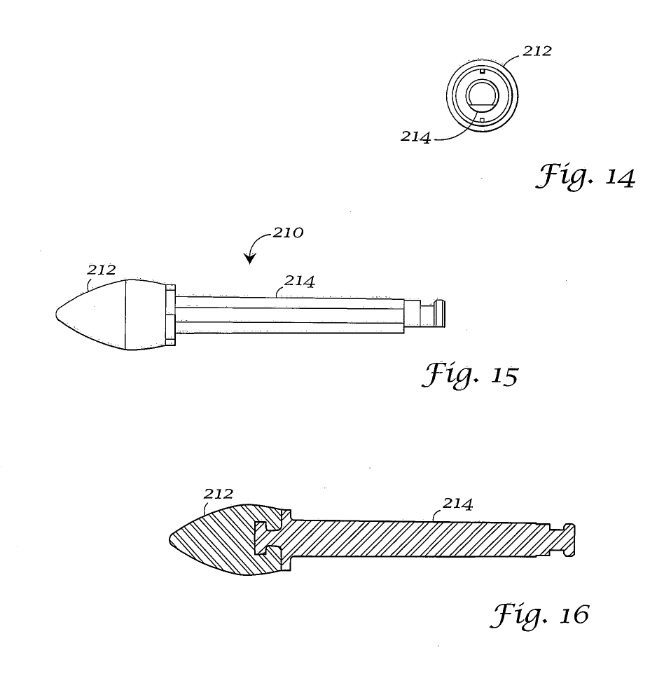

With more particular reference to FIGS. 14-16 is seen a dental polishing device 210 having a conical shaped polishing member 212 and a rigid support rod 214. Conical shaped polishing member 212 is made by molding dental polishing material onto rigid support rod 214. The dental polishing material includes elastomeric polymer impregnated with blocky synthetic diamond particles. The blocky synthetic diamond particles are effectively uniformly distributed within the elastomeric polymer.

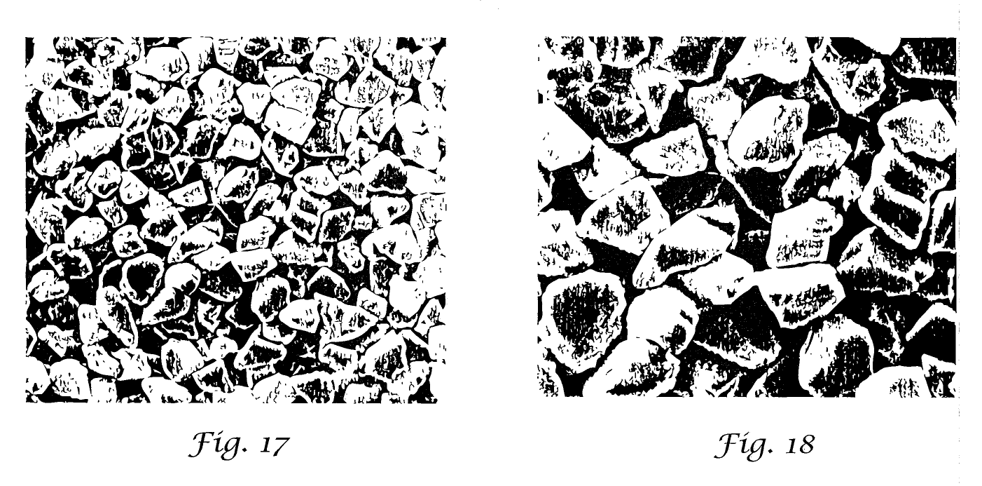

With more particular reference to FIGS. 17 and 18 is seen scanning electron micrographs of blocky synthetic diamond particles useful in dental polishing material of a dental polishing device of the invention. Blocky synthetic diamonds, as used herein, are effectively free of rod shape synthetic diamonds and plate shape synthetic diamonds.

The blocky synthetic diamond particles effectively have a mean particle size between 10 and 30 microns, and more preferably a mean particle size between 15 and 25 microns. The blocky synthetic diamond particles comprise more than 50 percent by weight of the dental polishing material. Preferably the blocky synthetic diamond particles comprise more than 60 percent by weight of the dental polishing material. More preferably the blocky synthetic diamond particles comprise more than 70 percent by weight of the dental polishing material.

Dental polishing material having a substantial portion of diamond particles is preferably adapted to reduce the surface roughness of dental composite filling material by at least 50 percent within 30 seconds, when applied as a rotating disc (conical or cup) shape under less than 30 psi pressure.

Preferably the blocky synthetic diamond particles consist essentially of blocky synthetic diamond particles having particle sizes from 2 to 50 microns. More preferably the blocky synthetic diamond particles effectively have particle sizes from 5 to 40 microns. Most preferably the blocky synthetic diamond particles consist essentially of particles effectively having particle sizes from 5 to 30 microns. Preferably the blocky synthetic diamond particles are not coated.

Blocky synthetic diamond powder particles for use in accordance with the invention preferably include from about 1 to about 8 ppm of nickel, from about 0.5 to about 6 ppm of lead, from about 5 to about 20 ppm of calcium, from about 1 to about 4 ppm of magnesium, from about 0.5 to about 1 ppm of zinc, from about 5 to about 40 ppm of iron, from about 4 to about 50 ppm of aluminum, from about 0.5 to about 5 ppm of chromium.

A tooth polishing method in accordance with a preferred embodiment of the invention includes forming a polishing member, which is sufficient, when rotated, to polish an unpolished dental tooth surface to less than 0.07 surface roughness average (sRa) μm (micron). Preferably the polishing member is sufficient, when rotated, to polish a dental tooth surface to a surface roughness of less than 0.06 sRa μm.

Preferably the method includes providing a support member supporting the polishing member. Preferably the polishing member is disc shaped, cup shaped or generally conical shaped. Preferably the method includes polishing restorative material supported by at least one tooth in a first patient's mouth with the polishing member. Preferably the method includes disposing of the polishing member without polishing restorative material supported by a tooth in a second patient's mouth with the dental polishing device. Preferably the polishing member includes dental polishing material having elastomeric polymer impregnated with blocky synthetic diamond particles, which effectively have a mean particle size between 5 and 25 microns, and comprise more than 50 percent by weight of the dental polishing material. Preferably, the polishing member is made of material having a tear strength of at least 3.3 lbs. More preferably, the polishing member is made of material having a tear strength of at least 4.0 lbs. Most preferably, the polishing member is made of material having a tear strength of at least 5.0 lbs. Tear strength, as used herein, refers to the force required to tear a material, and is measured using a Chatillon gauge, to measure the force required to tear polisher material by tearing a support from the bottom of a polisher. For example, the tear strength of disc shaped polishing member material having an embedded rigid support rod (such as shown in FIGS. 3-10), is the force required to tear the rigid support rod from the bottom of the disc as measured by a Chatillon gauge.

Polishing as used herein refers to polishing and/or abrading. A cut unpolished outer surface as used herein refers to an outer surface, which has been cut, but has not been polished (or abraded). Cutting is preferably carried out using a rotating dental burr. The material having a cut unpolished outer surface is a natural dental tooth or dental restorative material. Dental restorative material as used herein refers to metallic dental restorative materials, polymeric dental restorative materials and ceramic dental restorative materials. Metallic dental restorative materials include dental metal amalgams. Polymeric dental restorative materials include dental composite filling materials, which typically include inorganic filler particles in a polymeric matrix material. Ceramic dental restorative materials ceramic of ceramic prostheses, such as crowns and bridges.

A restorative polishing method in accordance with a preferred embodiment of the invention includes forming a polishing member, which is sufficient, when rotated, to polish an unpolished dental restorative material supported by a tooth in a patient's mouth to a surface roughness of less than 0.03 sRa μm. Dental restorative material as used herein refers to dental composite filling materials and dental amalgams. Dental composite filling materials are polymeric materials, which may contain inorganic and/or organic filler(s). For example, acrylic polymer containing about 60 percent by weight of glass powder. Dental amalgams are alloys of mercury and other metals.

Preferably the restorative material comprises at least 30 percent by weight of inorganic filler and at least 5 percent by weight of polymeric material. Preferably the restorative material comprises at least 20 percent by weight of polymeric material.

Preferably, the polishing member comprises at least 5 percent by weight of polymeric matrix material supporting abrasive particles and pore chambers. The abrasive particles have an average abrasive particle length, the pore chambers have an average pore chamber length, and the average pore chamber length is greater than the average abrasive particle length. Preferably the pore chambers effectively increase the flexibility of the polishing member.

A dental polishing method in accordance with a preferred embodiment of the invention includes forming a polishing member, rotating the polishing member while applying it to an unpolished restorative material supported by a tooth in a patient's mouth. The polishing member is adapted to polish a restorative material to a surface roughness of less than 0.03 sRa μm.

A dental polishing method in accordance with a preferred embodiment of the invention includes forming a polishing member, and polishing an unpolished restorative material supported by a tooth in a patient's mouth to a surface roughness of less than 0.03 sRa μm, The polishing consists essentially of rotating the polishing member while applying it to the restorative material.

A method of using a dental polishing device is provided in accordance with a preferred embodiment of the invention wherein a dental polishing device is provided having a polishing member and a support member. The polishing member includes dental polishing material including elastomeric polymer impregnated with blocky synthetic diamond particles. The synthetic diamond particles effectively have a mean particle size between 5 and 25 microns. The synthetic diamond particles comprising more than 50 percent by weight of the dental polishing material. Restorative material supported by at least one tooth in a first patient's mouth is polished with the dental polishing device to provide a surface roughness of less than 0.03 sRa μm in less than 60 seconds. The dental polishing device is then disposed of without polishing restorative material supported by a tooth in a second patient's mouth.

A method of smoothing the surface of a tooth is provided in accordance with a preferred embodiment of the invention wherein a dental polishing device is provided having a polishing member which includes dental polishing material having elastomeric polymer impregnated with blocky synthetic diamond particles. The synthetic diamond particles effectively have a mean particle size between 5 and 25 microns. The synthetic diamond particles comprise more than 50 percent by weight of the dental polishing material. The dental polishing device has a polishing member and a support member. The polishing member comprises dental polishing material, including elastomeric polymer impregnated with blocky synthetic diamond particles. The synthetic diamond particles effectively have a mean particle size between 5 and 25 microns. The synthetic diamond particles comprise more than 50 percent by weight of the dental polishing material. At least one unpolished dental tooth surface is polished in a first patient's mouth with the dental polishing device to provide a surface roughness of less than 0.07 sRa μm in less than 60 seconds. The dental polishing device is disposed of without polishing a tooth in a second patient's mouth with the dental polishing device.

Preferably each polishing member of the invention is sufficient, when rotated, to polish an outer surface of a natural dental tooth to a surface roughness of less than 0.07 sRa μm in less than 60 seconds, and to polish an outer surface of dental restorative material, supported by a tooth in a patient's mouth, to a surface roughness of less than 0.03 sRa μm in less than 60 seconds. More preferably each polishing member of the invention is sufficient, when rotated, to polish a dental tooth surface to a surface roughness of less than 0.06 sRa μm in less than 60 seconds, and to polish a dental restorative material, supported by a tooth in a patient's mouth, to a surface roughness of less than 0.02 sRa μm in less than 60 seconds.

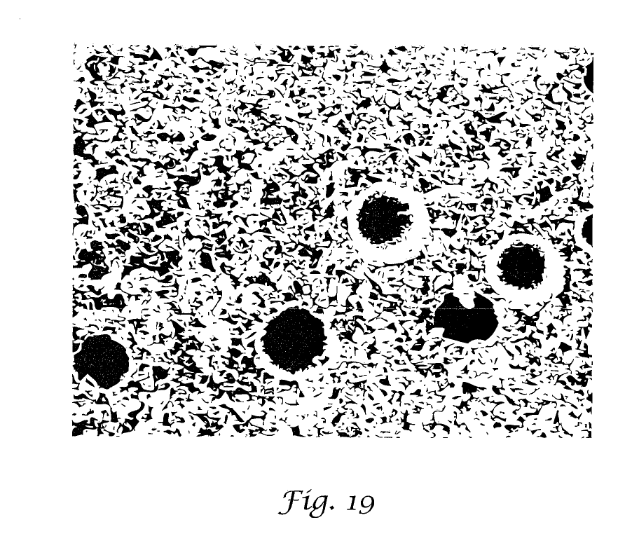

Preferably, each polishing member of the invention is flexible, for example due to the distribution of pores therein, as shown in FIG. 19. Thus, preferably, each polishing member of the invention includes pores and has a porosity of from about 1 percent by volume to about 40 percent by volume. More preferably, each polishing member of the invention has a porosity of from about 2 percent by volume to about 30 percent by volume. Most preferably, each polishing member of the invention has a porosity of from about 3 percent by volume to about 20 percent by volume. Preferably, the pores are spheroidal and have an average diameter of at least 30 microns.

A preferred embodiment of the invention provides a dental method including applying a single rotating polisher against an outer surface of an unpolished natural dental tooth, said polisher effectively polishing said outer surface to a surface roughness of less than 0.07 sRa μm. Preferably this polishing is completed in less than 2 minutes.

A preferred embodiment of the invention provides a dental method including applying a single rotating polisher against an outer surface of an unpolished dental restorative material supported by a tooth in a patient's mouth, said polisher effectively polishing said outer surface to a surface roughness of less than 0.03 sRa μm. Preferably this polishing is completed in less than 2 minutes.

The following examples are offered to aid in understanding the invention and are not to be construed as limiting its scope. Unless otherwise indicated, all parts and percentages are by weight.

### EXAMPLE 1

Urethane Resin

8.05 g of Polypropylene diol (molecular weight: 4000—equivalent weight: 2000) [Voranol 220-028], 64.28 g of Polypropylene diol (molecular weight: 2000—equivalent weight: 1000) [Voranol 220-056], 8.05 g of Polypropylene triol (molecular weight: 4990—equivalent weight: 1664) [Voranol 271], 0.025 g of Stannous octoate [T-9 Catalyst], 6.8 g of hydroxyethylmethacrylate (HEMA) and 12.8 g of trimethylhexamethylene diisocyanate (TMDI) are mixed. The mixture is then stirred at 55° C. for 72 hours, while reacting to form a resin mixture.

Synthetic Diamond Powder

The synthetic diamond powder is LS600T synthetic metal-bond crystal sold by LANDS SUPERABRASIVES CO. The synthetic diamond powder particles have consistent blocky shapes and particle sizes from 12 to 28 microns with more than 95 percent of the particles having particle sizes between 14 and 26 microns, and more than 75 percent of the particles having particle sizes between 18 and 22 microns.

Disc Shape:

25.18 g urethane resin, 1.8 g silicon dioxide, 72.5 g synthetic diamond powder, 0.18 g silane ester, 0.128 g peroxide and 0.19 g dihydroxethyl-p-toluidine are stirred to form a polymerizable mixture. The polymerizable mixture is poured into a mold to form a disc shape. A rigid polymeric support rod having the shape shown in FIGS. 6-8 is positioned in the mold and bonds to the disc as it polymerizes. The polymerizable mixture is cured at 23° C. for 20 minutes. A disc shaped polishing member supported by a rigid rod is formed. The disc shaped polishing member has the shape shown in FIGS. 3-6 with a 0.5 inch frontal diameter, a 0.15 inch rear diameter and a 0.2 inch center thickness, and a tear strength of 5.5 lbs.

### EXAMPLE 2

Synthetic Diamond Powder

The synthetic diamond powder is LS600T synthetic metal-bond crystal sold by LANDS SUPERABRASIVES CO. The synthetic diamond powder particles have consistent blocky shapes and particle sizes from 4 and 20 microns with more than 95 percent of the particles having particle sizes between 5 and 9 microns, and more than 75 percent of the particles having particle sizes between 3 and 10 microns.

Urethane Resin

8.05 g of Polypropylene diol (molecular weight: 4000—equivalent weight: 2000) [Voranol 220-028], 64.28 g of Polypropylene diol (molecular weight: 2000—equivalent weight: 1000) [Voranol 220-056], 8.05 g of Polypropylene triol (molecular weight: 4990—equivalent weight: 1664) [Voranol 271], 0.025 g of Stannous octoate [T-9 Catalyst], 6.8 g of hydroxyethylmethacrylate (HEMA) and 12.8 g of trimethylhexamethylene diisocyanate (TMDI) are mixed. The mixture is then stirred at 55° C. for 72 hours, while reacting to form a resin mixture.

Conical (Point) Shape Polishing Element

The resin mixture is mixed with 100 g of synthetic diamond powder to form a polymerizable mixture. The polymerizable mixture is poured into a mold to form an elongated conical (point) shape, as shown in FIG. 3. A polymeric rod is positioned in the mold and bonds to the elongated conical (point) shape, as the polymerizable mixture is cured at 23° C. for 20 minutes. A 0.275 inch long, 0.18 inch outer diameter polishing point having the shape shown in FIGS. 14-16 is removed from the mold, and a tear strength of 5.5 lbs.

### EXAMPLE 3

Synthetic Diamond Powder
The synthetic diamond powder is LS600T synthetic metal-bond crystal sold by LANDS SUPERABRASIVES CO. The synthetic diamond powder particles have consistent blocky shapes and particle sizes from 4 and 20 microns with more than 95 percent of the particles having particle sizes between 5 and 9 microns, and more than 75 percent of the particles having particle sizes between 3 and 10 microns.

Urethane Resin

55.53 g of Polypropylene diol (molecular weight: 4000—equivalent weight: 2000) [Voranol 220-028], 21.35 g of Polypropylene diol (molecular weight: 2000—equivalent weight: 1000) [Voranol 220-056], 8.55 g of Polypropylene triol (molecular weight: 4990—equivalent weight: 1664) [Voranol 271], 0.025 g of Stannous octoate [T-9 Catalyst], 5.05 g of hydroxyethylmethacrylate (HEMA) and 9.5 g of trimethylhexamethylene diisocyanate (TMDI) are mixed. The mixture is then stirred at 55° C. for 72 hours while reacting to form a resin mixture.

Cup Shape

This resin mixture is mixed with 100 g of the synthetic diamond powder to form a polymerizable mixture. The polymerizable mixture is poured into a mold to form a cup shape. A polymeric rod is positioned in the mold and bonds to the cup shape, as the polymerizable mixture is cured at 23° C. for 20 minutes. The molded product has a 0.2 inch long, 0.5 inch outer diameter polishing cup having the shape shown in FIGS. 11-13, and a tear strength of 5.5 lbs.

A disc made by following the procedure of Example 1, and commercially available disc polishing systems: Soflex sold by 3M and Astropol sold by Ivoclar, are used to polish (for 30 seconds under light hand pressure: about 1 psi to about 5 psi) surfaces of dental restorative material (Esthel-X sold by Dentsply International), which had been polished to a surface roughness of 0.255 sRa with 320 grit sandpaper. Polishing a tooth surface or a restorative material surface to a smooth surface with 320 grit sandpaper results in substantially equivalent surface smoothness to cutting the surface with a dental burr. The surface roughness of the dental restorative material is measured using a profilometer, and the results are shown in Table 1.

TABLE 1
COMPARISON WITH COMMERCIAL POLISHING SYSTEMS

| | | | | PERCENT |
|---|---|---|---|---|
| | | | | IMPROVEMENT |
| | | | | OF Example 1 |
| | Soflex | Astropol | Example 1 | IN SURFACE |
| | (3 disc) | (3 disc) | (1 disc) | ROUGHNESS |
| dental restorative | | 0.0291 | 0.0172 | 69 |
| material surface | | | | |
| roughness | | | | |
| (sRa μm) | | | | |
| dental restorative | 0.0486 | | 0.0172 | 183 |
| material surface | | | | |
| roughness | | | | |
| (sRa μm) | | | | |

This demonstrates that use of the single disc polisher of the invention results in substantially less surface roughness (at least 69 percent) compared to the commercially available three disc polishing systems, as shown in Table 1.

The single disc polisher of the invention eliminates the need to use multiple discs during polishing. The time required for polishing, when using the three disc polishing system of Astropol is about three times as long as, the time required for polishing, when using the single disc polishing system of Example 1. Additional time is required for changing discs, when using the three disc polishing system of Astropol. No additional time is required for changing discs, when using the single disc polishing system of Example 1.

A disc made by following the procedure of Example 1, commercially available disc polishing systems, Soflex sold by 3M and Astropol sold by Ivoclar, are used to polish surfaces of a natural dental tooth, which had been polished for 30 seconds with Nupro Prophy dental polishing paste (sold by Dentsply International) to a surface roughness of 0.1365 (sRa μm). The surface roughness is measured using a profilometer, and the results are shown in Table 2.

TABLE 2
COMPARISON WITH COMMERCIAL POLISHING SYSTEMS

| | Soflex | Astropol | | PERCENT |
|---|---|---|---|---|
| | (fine | (finest | Example 1 | IMPROVEMENT |
| | disc | disc | (single | OF Example 1 |
| | used) | used) | disc) | IN SURFACE |
| | (30 sec) | (30 sec) | (30 sec) | ROUGHNESS |
| tooth surface | | 0.0810 | 0.0588 | 38 |
| roughness | | | | |
| (sRa μm) | | | | |
| tooth surface | 0.1081 | | 0.0588 | 84 |
| roughness | | | | |
| (sRa μm) | | | | |

This demonstrates that use of the polisher of the invention results in substantially less surface roughness (at least 38 percent) compared to polishing of these commercially available disc polishing systems, as shown in Table 2.

A disc made by following the procedure of Example 1, and two commercially available disc polishing systems, Soft flex sold by 3M, and Astropol sold by Ivoclar, are used to polish surfaces of dental restorative material (Esthel-X sold by Dentsply International), which had been polished to a surface roughness of 0.132 (sRa μm). The surface roughness of the restorative is measured using a profilometer, and the results are shown in Table 3.

TABLE 3
COMPARISON WITH COMMERCIAL POLISHING SYSTEMS

| | Soft flex | Astropol | | PERCENT |
|---|---|---|---|---|
| | (1 disc: | (1 disc: | | IMPROVEMENT |
| | finest | finest | Example 1 | OF Example 1 |
| | used) | used) | (1 disc) | IN SURFACE |
| | (30 sec) | (30 sec) | (30 sec) | ROUGHNESS |
| dental restorative | 0.0296 | | 0.0151 | 96 |
| material surface | | | | |
| roughness (sRa | | | | |
| μm) on glass | | | | |
| dental restorative | | 0.0202 | 0.0151 | 34 |
| material surface | | | | |
| roughness (sRa | | | | |
| μm) on glass | | | | |

This demonstrate that use of the single disc polisher of the invention results in substantially less surface roughness (at least 34 percent) compared to the polisher disc of these commercially available polishing systems, as shown in Table 3.

It should be understood that while the present invention has been described in considerable detail with respect to certain specific embodiments thereof, it should not be considered limited to such embodiments but may be used in other ways without departure from the spirit of the invention and the scope of the appended claims.

What is claimed is:

1. A dental method comprising:
applying a single rotating polisher against a cut unpolished outer surface of a natural dental tooth having a surface roughness greater than 0.10 sRa μm, said polisher effectively polishing said outer surface to a surface roughness of less than 0.07 sRa μm.

2. The method of claim 1 wherein said polisher effectively polishes said outer surface to a surface roughness of less than 0.07 sRa μm while said polisher is pressing against said outer surface for less than 60 seconds.

3. The method of claim 1 wherein said polisher is not applied to a second patient.

4. The method of claim 1 wherein said polisher comprises a polishing member and a support member, said polisher is supported by said support member, and said polishing member is made of material having a tear strength of at least 4.0 lbs.

5. The method of claim 4 wherein said polishing member is disc shaped, cup shaped or generally conical shaped.

6. A dental method comprising:
applying a single rotating polisher against a cut unpolished outer surface of a dental restorative material having a surface roughness greater than 0.10 sRa μm and supported by a tooth in a patient's mouth, said polisher effectively polishing said outer surface to a surface roughness of less than 0.03 sRa μm.

7. The method of claim 6 wherein said polisher effectively polishes said outer surface to a surface roughness of less than 0.03 sRa μm while said polisher is pressing against said outer surface for less than 60 seconds.

8. The method of claim 6 wherein said polisher is not applied to a second patient, said polisher comprises a polishing member and a support member, said polisher is supported by said support member, said polishing member is disc shaped, cup shaped or generally conical shaped.

9. The method of claim 6 wherein said polisher comprises a polishing member, and said polishing member is disc shaped, cup shaped or generally conical shaped, and said polishing member is made of material having a tear strength of at least 5.0 lbs.

10. A dental polishing method comprising:
forming a polishing member, said polishing member being sufficient, when rotated, to polish a cut unpolished dental restorative material supported by a tooth in a patient's mouth to a surface roughness of less than 0.03 sRa μm.

11. The method of claim 10 wherein said dental restorative material comprises at least 30 percent by weight of inorganic filler and at least 5 percent by weight of polymeric material.

12. The method of claim 10 wherein said dental restorative material comprises at least 5 percent by weight of polymeric matrix material, said polymeric matrix material supporting abrasive particles and pore chambers, said abrasive particles having an average abrasive particle length, said pore chambers having an average pore chamber length, said average pore chamber length being greater than said average abrasive particle length.

13. A method of using a dental polishing device comprising:
providing a dental polishing device having a polishing member and a support member, said polishing member comprising dental polishing material, said dental polishing material comprising elastomeric polymer impregnated with blocky synthetic diamond particles, said synthetic diamond particles effectively having a mean particle size between 5 and 25 microns, said synthetic diamond particles comprising more than 50 percent by weight of said dental polishing material,
polishing dental restorative material supported by at least one tooth in a first patient's mouth with said dental polishing device, and
disposing of said dental polishing device without polishing dental restorative material supported by a tooth in a second patient's mouth with said dental polishing device.

14. The method of claim 13 wherein said dental restorative material is selected from the group consisting of polymeric material, metal amalgam, and ceramic.

15. A dental polishing device comprising:
a polishing member and a support member,
said polishing member comprising dental polishing material,
said dental polishing material comprising elastomeric polymer impregnated with blocky synthetic diamond particles,
said synthetic diamond particles effectively having a mean particle size between 10 and 30 microns, said synthetic diamond particles comprising more than 50 percent by weight of said dental polishing material.

16. The dental polishing device of claim 15 wherein said synthetic diamond particles comprise more than 60 percent by weight of said dental polishing material, and said polishing member consists essentially of material having a tear strength of at least 4.0 lbs.

17. The dental polishing device of claim 15 wherein said synthetic diamond particles comprise more than 70 percent by weight of said dental polishing material.

18. The dental polishing device of claim 15 wherein said polishing member is disc shaped, cup shaped or generally conical shaped.

19. The dental polishing device of claim 15 wherein said material is adapted to reduce the surface roughness of dental composite filling material by at least 50 percent within 30 seconds, when applied as a rotating disc under pressure of less than 50 psi.

20. The dental polishing device of claim 15 wherein said synthetic diamond particles effectively having particle sizes from 5 to 40 microns.

21. The dental polishing device of claim 15 wherein said synthetic diamond particles consist essentially of particles effectively having particle sizes from 10 to 30 microns.

22. The dental polishing device of claim 15 wherein said synthetic diamond particles effectively have a mean particle size between 15 and 25 microns.

23. The dental polishing device of claim 22 wherein said synthetic diamond particles consist essentially of synthetic diamond particles having particle sizes from 2 to 50 microns, said synthetic diamond particles comprises more than 60 percent by weight of said dental polishing material.

24. The dental polishing device of claim 15 wherein said polishing member comprises pores and said polishing member has a porosity of from about 2 percent by volume to about 30 percent by volume.

25. The dental polishing device of claim 15 wherein said polishing member comprises pores and wherein said pores are spheroidal and have an average diameter of at least 30 microns.

26. A method of smoothing the surface of a tooth comprising:
providing a dental polishing device having a polishing member and a support member, said polishing member comprising dental polishing material, said dental polishing material comprising elastomeric polymer impregnated with blocky synthetic diamond particles, said synthetic diamond particles effectively having a mean particle size between 5 and 25 microns, said synthetic diamond particles comprising more than 50 percent by weight of said dental polishing material,
polishing a surface of dental restorative material supported by at least one tooth in a first patient's mouth with said dental polishing device to polish said surface of restorative material a surface roughness of less than 0.03 sRa μm in less than 60 seconds and
disposing of said dental polishing device without polishing restorative material supported by a tooth in a second patient's mouth with said dental polishing device.

27. The method of claim 26 wherein said elastomeric polymer is formed from polypropylene diol (molecular weight: 4000—equivalent weight: 2000), polypropylene diol (molecular weight: 2000—equivalent weight: 1000), polypropylene triol (molecular weight: 4990—equivalent weight: 1664), hydroxyethylmethacrylate (HEMA) and trimethylhexamethylene diisocyanate (TMDI).

28. A dental method comprising:
polishing an outer surface of a natural dental tooth and a cut unpolished outer surface of dental restorative material supported by a tooth in a patient's mouth with a polishing member, said outer surface of said natural dental tooth being polished to a surface roughness of less than 0.07 sRa μm, and said outer surface of dental restorative material being polished to a surface roughness of less than 0.03 sRa μm.

29. The method of claim 28 wherein said outer surface of said natural dental tooth surface is polished to a surface roughness of less than 0.06 sRa μm, and said outer surface of said dental restorative material is polished to a surface roughness of less than 0.02 sRa μm.

30. The method of claim 28 further comprising providing a support member, said polishing member being supported by said support member.

31. The method of claim 28 wherein said polishing member is disc shaped, cup shaped or generally conical shaped.

32. The method of claim 28 further comprising polishing restorative material supported by at least one tooth in a first patient's mouth with said polishing member.

33. The method of claim 32 further comprising
disposing of said polishing member without polishing restorative material supported by a tooth in a second patient's mouth with said dental polishing device.

34. The method of claim 28 wherein said polishing member comprising dental polishing material, said dental polishing material comprising elastomeric polymer impregnated with blocky synthetic diamond particles, said synthetic diamond particles effectively having a mean particle size between 5 and 25 microns, said synthetic diamond particles comprising more than 50 percent by weight of said dental polishing material.
